(19) United States
(12) Patent Application Publication
(10) Pub. No.: US 2005/0055284 A1
(43) Pub. Date: Mar. 10, 2005

(54) Web page electronic business device which provides flower shop with instant sound and images

(76) Inventors: Heng-Jui Chang, Taipei (TW); Li Wen Wang, Taipei (TW)

Correspondence Address: Heng-Jui Changq, PO Box 82-144, Taipei, TW

(21) Appl. No.: 10/656,111

(22) Filed: Sep. 8, 2003

(51) Int. Cl. G06F 17/60

(52) U.S. Cl. 705/27

(57) ABSTRACT

An electronic business device on web page for flower shops which provides instant sound and image. This electronic business device allows electronic purchasing and it not only provides the convenience of web page order but also provides direct selection of flower product by consumers. The consumers can directly communicate with the flower shop to proceed with interaction. The electronic business device allows the consumer to process with ordering and purchasing similar to purchasing on the spot.

### BACKGROUND OF THE INVENTION

(a) Technical Field of the Invention

The present invention relates to web page electronic business device which provides flower shop with instant sound and images, and in particular, a method of purchasing from the flower shop. The present invention is an electronic business device which is a combination of a simulation and the reality and convenience of electronic commerce.

(b) Description of the Prior Art

Flower purchasing is common for festive seasons as well as in funerals. Flower purchasing now becomes very common in celebration of birthday, Valentine's Day or a special memorial day.

As shown in FIG. 1, the purchasing of flower is by way of directly approaching the flower shop. However, the flower shops have a restrain with respect to time and space. Further, flower shop will not be able to overcome the geographical restriction in getting purchase order. Referring to FIG. 2, there is shown another method of flower purchasing by way of electronic information and Internet 2. The consumer 1 orders the product provided by the website provider 3 based on the photograph and pattern. The provider 3 takes in the order and proceeds to the destination. Orders are distributed between flower shops ends, a, b, c, d.

As a result, the flower shop has the characteristics of specific region and type. As a result, when the consumer gets the flora, unsatisfaction to the product by the consumers may be occurred.

Accordingly, it is an object of the present invention to provide a web page electronic business device which provides flower shop with instant sound and images which can mitigates the above drawbacks.

### SUMMARY OF THE INVENTION

Accordingly, it is an object of the present invention to provide (a) the present invention relates to electronic business device on web page for flower shops which provides instant sound and image. This electronic business device allows electronic purchasing and it not only provides the convenience of web page order but also provides direct selection of flower product by consumers. The consumers can directly communicate with the flower shop to proceed with interaction. The electronic business device allows the consumer to process with ordering and purchasing similar to purchasing on the spot.

Yet another object of the present invention is to provide a web page electronic business device which provides flower shop with instant sound and images wherein the electronic business device provides the consumer a reliable and convenient way of electronic website purchase. This overcomes the excessive cost of electronic shopping and which ensure the quality of product on the electronic commerce system.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view of a conventional electronic business device.

FIG. 2 is a schematic view of a second conventional electronic business device.

FIG. 3 and FIG. 4 are flowchart showing the flowchart.

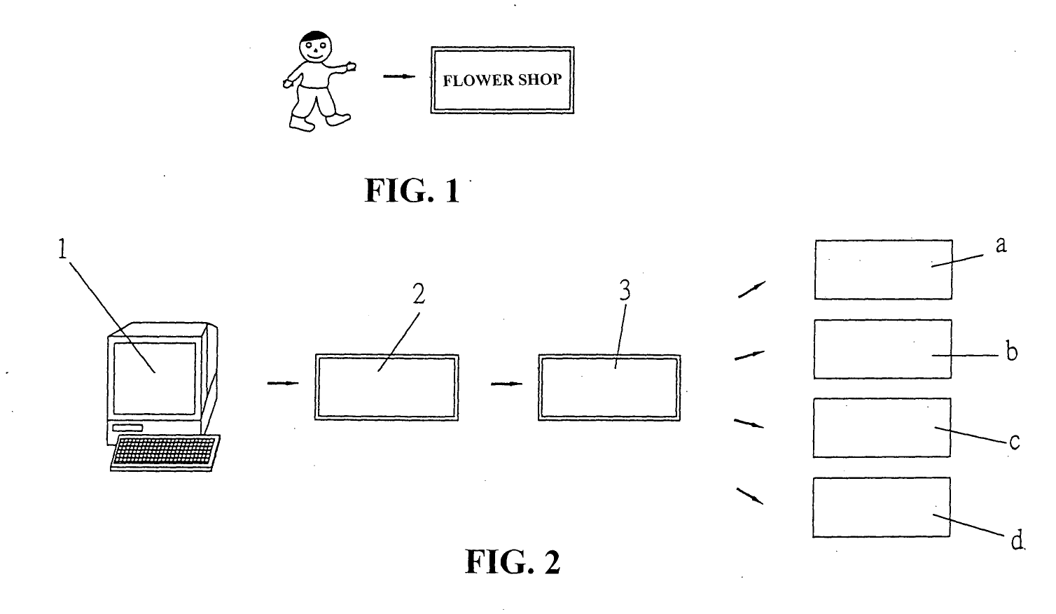

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

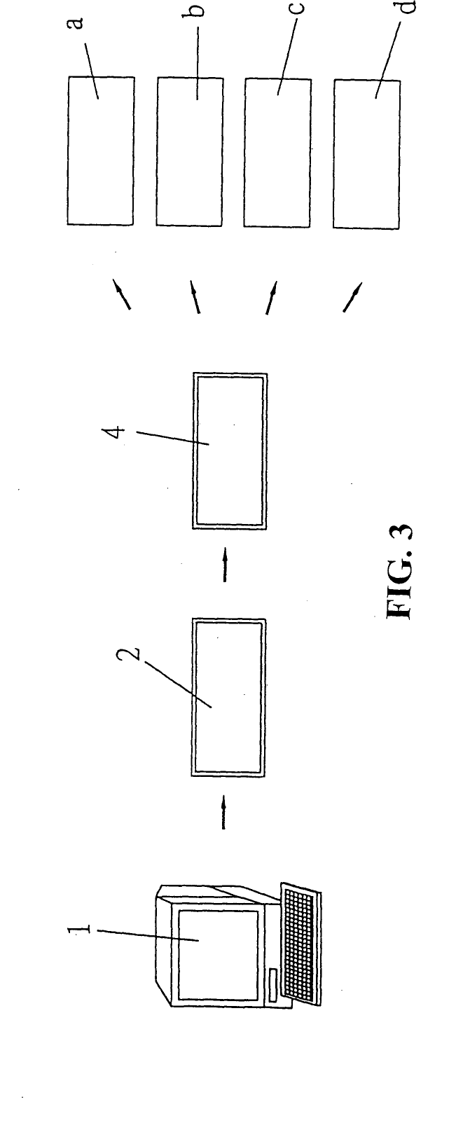

Referring to FIGS. 3, and 4, there is shown an e-commerce device providing instant voice and image for web page purchasing from flower shop comprises a server 41, servicing button 42, voice and image combined service device 43, wherein the server is linked to at least web page of the flower shop end having at least a servicing button 42, the servicing button 42 is corresponding and links to the voice and image combined service device 43 of the flower shop end web page, the voice and image combined service device 43 is used to transmit a related information to correspond to the servicing button 42, and is directly connected to a surfing device at the customer end and the voice and image combined service device 43 at the flower shop end, whereby the customer end can directly choose product from the flower shop and interact with the flower shop end.

In application, customer end (1) (consumer) requests for linking to the server 41 of the system end 4 via Internet 2. Upon recognition 44 by the server 41, the database 45 provides the web page of a flower shop ends a, b, c, and d to the customer end 1. The web page of the flower ends a, b, c, d is provided with a special servicing button 42 so that the customer end 1 selects the servicing button 42 of the web page of the flower shop ends a, b, c, d, the server 41 of the system will link to the servicing button 42 corresponding to the voice and image servicing device 43 of the flower shop ends a, b, c, d and the signal is directly transmitted to the customer end 1. The customer end 1 can select or direct select product of the flower shop via the service of the system 4 and can directly on line communicate with the service man on the flower shop end a, b, c, d.

There are advantages in accordance with the present invention.
(1) Customer can directly select the desired product via the voice and image combined servicing device of the system from the flower shop.
(2) Direct communication with respect of product details and price. Thus, cost paid to service provider is reduced and a reasonable price is negotiated.
(3) There is no geographical restriction, and therefore it is an extremely convenient means of e-commerce device.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. An e-commerce device providing instant voice and image for web page purchasing from flower shop comprises a server, servicing button, voice and image combined service device, wherein the server is linked to at least web page of the flower shop end having at least a servicing button, the servicing button is corresponding and links to the voice and image combined service device of the flower shop end web page, the voice and image combined service device is used to transmit a related information to correspond to the servicing button, and is directly connected to a surfing device at the customer end and the voice and image combined service device at the flower shop end, whereby the customer end can directly choose product from the flower shop and interact with the flower shop end.

2. The e-commerce device of claim 1, wherein the electronic commerce device is used to provide web page purchasing from the flower shop, and the server is linked to at least web page of the flower shop end having at least a servicing button, the servicing button is corresponding and links to the voice and image combined service device of the flower shop end web page, the voice and image combined service device is used to transmit a related information to correspond to the servicing button, and is directly connected to a surfing device at the customer end and the voice and image combined service device at the flower shop end, whereby the customer end can directly choose product from the flower shop and interact with the flower shop end.
